(19) United States
(12) Patent Application Publication
(10) Pub. No.: US 2023/0150405 A1
(43) Pub. Date: May 18, 2023

(54) SEAT SURFACE PERFORATIONS

(71) Applicant: Lear Corporation, Southfield, MI (US)

(72) Inventors: Karl W. Henn, New Hudson, MI (US); Bradley C. Duncan, Harrison Township, MI (US); Vyachislav Ivanov, West Bloomfield, MI (US)

(73) Assignee: Lear Corporation, Southfield, MI (US)

(21) Appl. No.: 17/526,352

(22) Filed: Nov. 15, 2021

(51) Int. Cl. B60N 2/58; B60N 2/56

(52) U.S. Cl. CPC B60N 2/58; B60N 2/5635; B60N 2/5657

(57) ABSTRACT

A seat includes comprising: a seat bottom and a seat back operatively engaging the seat bottom. At, least one of the seat back and the seat bottom has an air impermeable outer trim layer covering at least a portion of an outer surface. The air impermeable outer trim layer includes perforations extending therethrough. The, size, spacing, or both of the perforations varies based at least in part on a body pressure map, and the perforations are configured to allow airflow therethrough directed toward an occupant of the seat.

### BACKGROUND OF THE INVENTION

This invention relates to a seat, and more particularly to a seat having surface perforations.

Seats, such as for example vehicle seats, are known that provide for heating, cooling or both via airflow from the seat (heating or cooling or both via convection) toward the person occupying the seat (sometimes referred to as climate controlled seats). In some climate controlled seats, the seat may have a surface (an outer trim layer) formed from leather, with a plurality of perforations formed through the outer trim layer to permit flow of heated and/or cooled air therethrough to heat/cool the occupant.

### SUMMARY OF THE INVENTION

According to an aspect, the invention provides a seat comprising a seat bottom; and a seat back operatively engaging the seat bottom, with at least one of the seat back and the seat bottom having an air impermeable outer trim layer covering at least a portion of an outer surface, the air impermeable outer trim layer including perforations therethrough, wherein the size, spacing or both of the perforations varies based at least in part on a body pressure map, and wherein the perforations are configured to allow airflow therethrough directed toward an occupant of the seat.

According to an aspect, the invention provides a seat comprising a seat bottom; and a seat back operatively engaging the seat bottom, with at least one of the seat back and the seat bottom having an air impermeable outer trim layer covering at least a portion of an outer surface, the air impermeable outer trim layer including perforations therethrough, wherein the outer trim layer of at least one of the seat bottom and the seat back comprises a first area, generally associated with a first body pressure of a body pressure map, having a first air permeability resulting from a size, spacing or both of the perforations, and a second area, generally associated with a second body pressure of the body pressure map that is on average lower than the first body pressure, having a second air permeability that is lower than the first air permeability, and wherein the perforations are configured to allow airflow therethrough directed toward an occupant of the seat.

According to an aspect, the invention provides a climate controlled seat having a perforation pattern for directional airflow from a seat surface (particularly a surface having an impermeable outer trim layer)—having areas with different air permeabilities (varying sizes, varying spacing of perforations, or both) based at least in part on body pressure map. Airflow may be redirected or increased/decreased to areas of a seat’s surface where it will have a greater and a quicker effect on the human thermal sensation and comfort, thereby improving human thermal comfort for the seat occupant. Registered holes (holes in an outer surface of the air impermeable outer trim layer that do not penetrate completely through the outer trim layer) may be employed to provide for an esthetically pleasing pattern on the seat surface, even though the perforations vary to create the different air permeabilities.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a schematic view of a vehicle seat.

FIGS. 2A and 2B are schematic views of a body pressure map on a seat back and seat bottom, respectively.

FIGS. 3A and 3B are schematic views of surface perforations on a seat back and seat bottom, respectively.

FIGS. 4A and 4B are schematic views of surface perforations on a seat back and seat bottom, respectively.

FIGS. 5A and 5B are schematic views of surface perforations on a seat back and seat bottom, respectively.

FIGS. 6A and 6B are schematic views of surface perforations on a seat back and seat bottom, respectively.

FIGS. 7A and 7B are schematic views of surface perforations on a seat back and seat bottom, respectively.

FIGS. 8A and 8B are schematic views of surface perforations on a seat back and seat bottom, respectively.

### DETAILED DESCRIPTION OF THE PREFERRED EMBODIMENTS

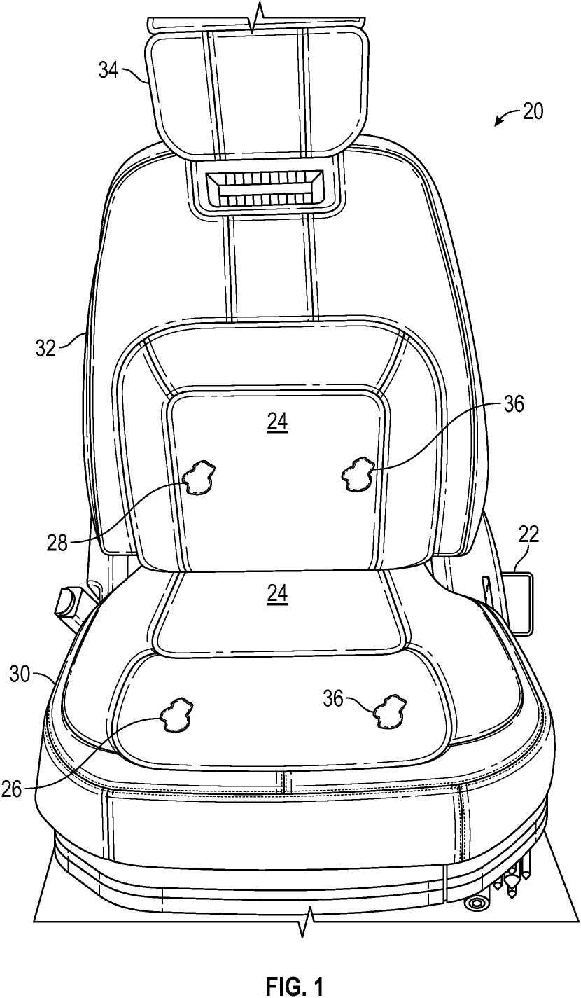

Referring now to the drawings, there is illustrated in FIG. 1 a seat 20, which may be a vehicle seat, which seat 20 is climate controlled. The seat 20 may have a seat bottom (seat cushion) 30, a seat back 32 operatively engaging the seat bottom 30, and a headrest 34 operatively engaging the seat back 32. Such a climate controlled seat 20 may have a climate control system 22 (e.g., comprising a heating system, a cooling system, a fan and control electronics) that provides heated air, cooled air or both to flow though an outer trim layer (outer surface) 24 of the seat bottom 30, seat back 32 or both onto the occupant of the seat 20. A climate control system 22 (shown schematically in FIG. 1) that provides heated and/or cooled air to a seat is known in the art and so will not be discussed in more detail herein. The outer trim layer 24 may be made of an air impermeable material (air impermeable surface), such as for example leather or vinyl. The seat 20 may also include a three-dimensional mesh or spacer fabric layer (air diffuser) 26 (shown schematically in FIG. 1) in the seat bottom 26, seat back 28 or both that allows the heated/cooled air to flow to various areas of the seat. For a climate controlled seat 20 with air ventilation a three-dimensional mesh or spacer fabric layer (air diffuser) 26 behind the air-impermeable outer trim layer 24 may distribute airflow across/within the seat bottom (seat cushion) 30 and seat back 32. A three-dimensional mesh or spacer fabric layer in the seat bottom and seat back is known in the art and so will not be discussed in more detail herein. A trim cover foundation 36 (shown schematically in FIG. 1) may be located between the three-dimensional mesh or spacer fabric layers 26, 28 and the outer trim layer 24. A trim cover foundation is known in the art and so will not be discussed in more detail herein. Heated and/or cooled air may be directed throughout the three-dimensional mesh or spacer fabric layers 26, 28 and through the trim cover foundation 36 to the outer trim layer 24. For a seat having an air impermeable surface, then, perforations (discussed below) are needed to allow air to flow onto the occupant of the seat 20 from the seat climate control system 22.

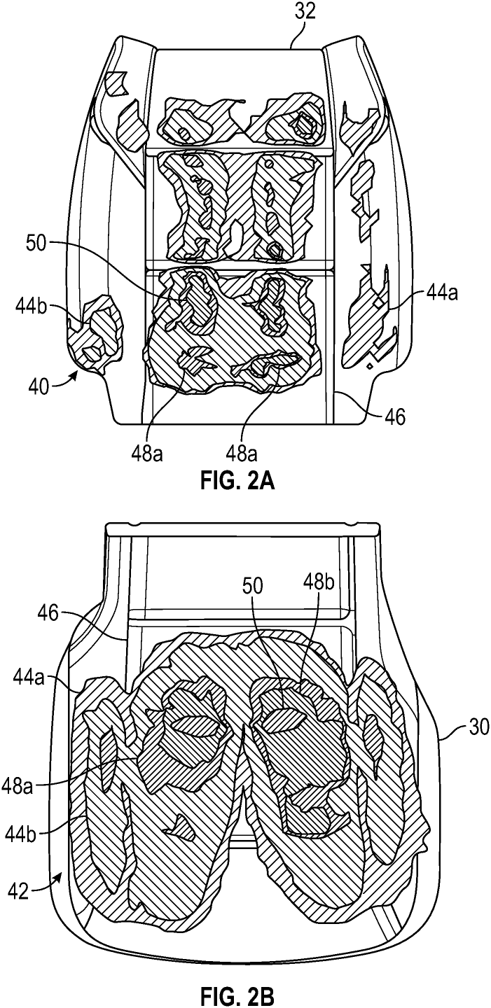

Referring now to FIGS. 2A and 2B, in view of FIG. 1, a schematic view of a seat back body pressure map 40 relative to the seat back 32 is illustrated in FIG. 2A, and a schematic view of a seat bottom body pressure map 42 relative to the seat bottom 30 is illustrated in FIG. 2B. A body pressure map indicates pressures of a seat occupant at various locations on the seat, which may be due in part to a weight distribution of the occupant. As can be seen from this example of body pressure maps 40, 42, the distribution of the weight of a seat occupant is not uniform throughout the seat 20. The body pressure maps 40, 42 may be based on a fiftieth percentile human occupying the seat (as in the example shown)—although other heights, shapes and weights of humans may be employed in producing the body pressure maps 40, 42. Crosshatching shown in FIGS. 2A and 2B represent one example showing the possible varying pressures on the seat bottom 30 and seat back 32 due to an occupant sitting on the seat. For example, low body pressure areas 44a and 44b (with 44b being areas subjected to a relatively higher body pressure than 44a) may be adjacent to trenches 46 in the seat bottom 30 and seat back 32. Low body pressure areas 44a, 44b may be farther outboard from vertical and fore-aft trenches 46 in the seat bottom 30 and seat back 32. Low body pressure areas 44a, 44b may be generally between a seat occupant’s legs (with some areas between the seat occupant’s legs not being subjected to body pressure, i.e., no body pressure). Low body pressure areas 44a, 44b may be generally adjacent to an occupant’s upper back and shoulders on the seat back 32. Continuing with this particular example, medium body pressure areas 48a and 48b (with 48b being areas subjected to a relatively higher body pressure than 48a) may be located on the seat bottom 30 adjacent to a seat occupant’s upper thighs and periphery of a buttocks. The medium body pressure areas 48a, 48b are subjected to greater body pressure than low body pressure areas 44a, 44b. Medium body pressure areas 48a, 48b may be located on the seat back 32 adjacent to an occupant’s lower back (on either side of an occupant’s spine). Medium body pressure areas 48a, 48b may be located on the seat back 32 adjacent to an occupant’s shoulder blades. Continuing with this particular example, high body pressure areas 50 may be located on the seat bottom 30 under a seat occupant’s buttocks. The high body pressure areas 50 are subjected to greater body pressure than medium body pressure areas 48a, 48b. High body pressure areas 50 may be located on the seat back 32 adjacent to an occupant’s lower back (on either side of an occupant’s spine). High body pressure areas 50 may be located on the seat back 32 behind an occupant’s shoulder blades.

For a climate controlled seat 20 with air ventilation having uniform sizes and spacing of perforations, when an occupant is sitting on the seat 20, airflow may be more restricted in areas where the three-dimensional mesh or spacer fabric layer 26, 28 is significantly compressed by the occupant’s body pressure. Additionally, for a climate controlled seat 20 with air ventilation, when an occupant is sitting on the seat 20, some perforations (holes through the outer trim layer 24 created to allow for air flow through an impermeable material) may be partially or completely blocked in areas where the outer trim (seat) surface 24 is in contact with the occupant. Such effects of higher body pressure acting on various areas of the seat 20 may reduce the ability of the heated and/or cooled air to flow through the surface 24 in those areas to heat/cool the occupant. Accordingly, a seat occupant may receive limited cooling sensation in areas with greater body pressure pressing against the outer trim (seat) surface 24 when uniform sizes and spacing of perforations are employed.

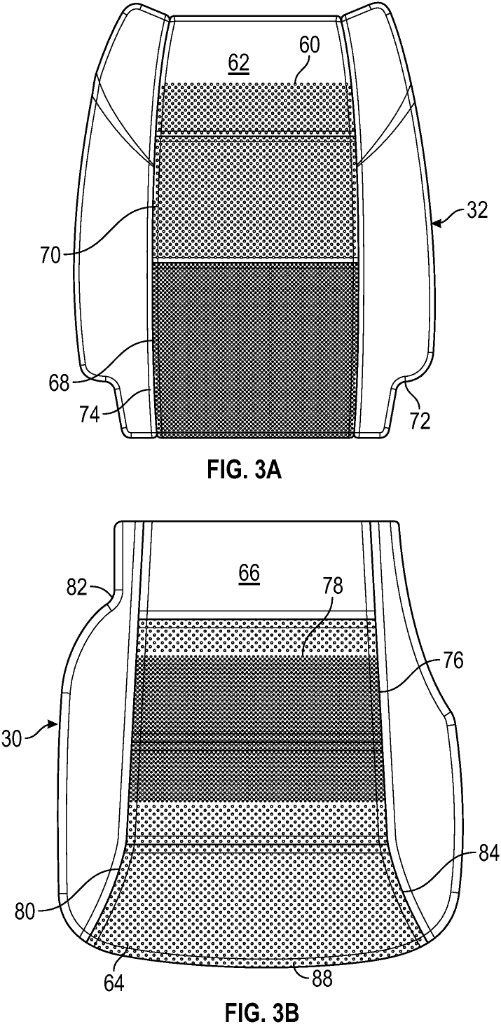

Referring now to FIGS. 3A and 3B, in view of FIG. 1-2B, a schematic view of a seat back 32 having perforations 60 through air impermeable portions of its outer trim layer 62 is illustrated in FIG. 3A and a schematic view of a seat bottom 30 having perforations 64 through air impermeable portions of its outer trim layer 66 is illustrated in FIG. 3B. The air impermeable portions of the outer trim layers 62, 66 may be made of, for example, leather, vinyl or both, or some other air impermeable material. In this example, the seat back 32 has a higher density of perforations 60 (higher air permeability) in a lower back area 68 of the outer trim layer 62 that is adjacent to the area that a seat occupant’s lower back may be disposed when sitting in the seat relative to the density of perforations (lower air permeability) in an upper back area 70 of the outer trim layer 62 that is adjacent to the area that a seat occupant’s lower back may be disposed. In this example, while the perforations 60 may possibly be larger in the upper back area relative to the lower back area, the overall air permeability may be lower due to the total area for airflow through the perforations being less. For the side support areas 72 that are outboard of the lower 68 and upper 70 back areas (outboard of trenches 74), these areas 72 may have very few or no perforations. One may note that the body pressure map of FIG. 2A shows an overall higher body pressure in the lower back area than in the upper back area, and lowest body pressure outboard of the trenches 74. Thus, when the climate control system 22 of the seat 20 is on, with airflow through the perforations 60, the thermal comfort relative to the occupant’s back may be improved. Also, while in this example the variations of the air permeability through different areas of the seat back 32 (perforation pattern) do not match the body pressure map precisely in all respects, some deviation from the body pressure map may be employed to maintain a certain esthetic look of the seat surface.

With regard to FIG. 3B, in this example, the seat bottom 30 has a higher density of perforations 76 (higher air permeability) in a seat buttock area 78 of the outer trim layer 66 that is adjacent to the area that a seat occupant’s buttock may be disposed when sitting in the seat relative to the density of perforations (lower air permeability) in a thigh area 80 of the outer trim layer 66 that is adjacent to the area that a seat occupant’s thighs may be disposed. In this example, while the perforations 64 may possibly be larger in the thigh area relative to the buttock area, the overall air permeability may be lower due to the total area for airflow through the perforations being less. For the side support areas 82 that are outboard of the areas 78, 80 (outboard of trenches 84), these areas 82 may have very few or no perforations. One may note that the body pressure map of FIG. 2B shows an overall higher body pressure in the buttock area 78 than in the thigh area 80, and lowest body pressure outboard of the trenches 84. Thus, when the climate control system 22 of the seat 20 is on, with airflow through the perforations 64, the thermal comfort relative to the occupant’s buttock and legs may be improved. Also, while in this example the variations of the air permeability through different areas of the seat bottom 30 (perforation pattern) do not match the body pressure map precisely in all respects, some deviation from the body pressure map may be employed to maintain a certain esthetic look of the seat surface.

In the examples disclosed herein, the seat surface areas outside of body pressure perimeter (outside of where the occupant’s body applies significant pressure to the seat surface) may have a higher airflow restriction (lower air permeability; less density, smaller holes or both) than areas inside the body pressure perimeter. An example of a ratio in airflow restriction may be about 3 to 1 — three times higher airflow restriction outside of body pressure perimeter. Although, other ratios may be employed instead. In this example, air permeability inside of the body pressure perimeter may be about 100 (feet cubed per feet squared per minute (f3/f2/min)) at a pressure of 20 Pascal (Pa), so air permeability outside of body pressure perimeter may have an air permeability of about 30 (f3/f2/min). Also, in the examples disclosed herein, the seat surface along (adjacent to) trenches (e.g., within a width of about one inch from trenches) may have a lower air permeability, for example less than about 30 (f3/f2/min) or possibly no air flow perforations at all since the air flow in and adjacent to the trenches may provide minimal effect of occupant thermal comfort. Similarly, for the examples disclosed herein, the amount of air flowing through the perforations (air permeability) to the areas of the seat that are not in contact with the occupant at all (such as the area between the occupant’s thighs) may be reduced by creating about the same resistance to airflow there than to any other place in the seat (e.g., less than about 30 (f3/f2/min) or possibly no air flow. Additionally, in the examples illustrated herein, one may employ registered holes 88 (i.e., holes in the outer surface that do not extend all of the way through the surface material) to create an appearance of a perforation pattern in order to keep seat surface appearance somewhat more uniform. For example, using registered holes 88 on the seat bottom 30 in an area between an occupant’s thighs.

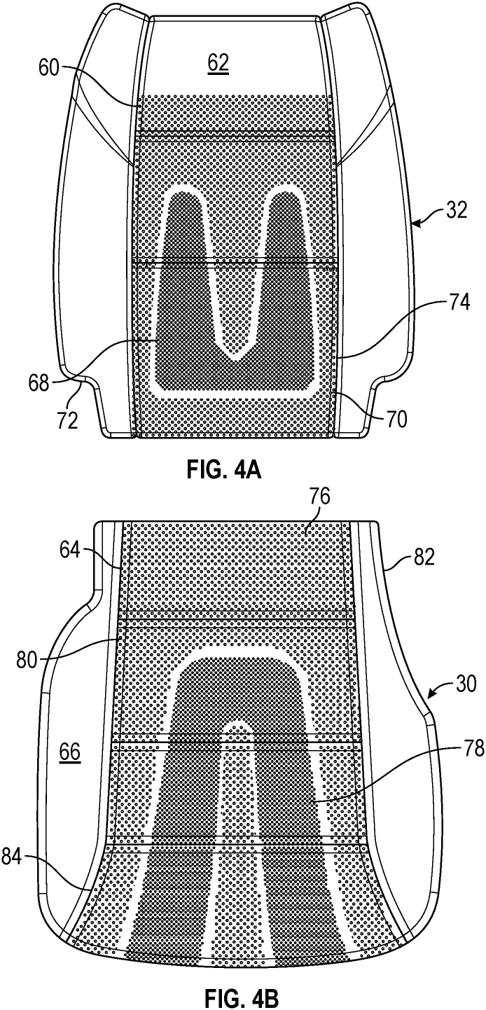

FIGS. 4A-8B, in view of FIG. 1-2B, illustrate various examples of arrangements of perforations in seat backs 32 and seat bottoms 30 wherein the size, spacing or both of the perforations 60, 64 through the outer trim layers 62, 66 varies based at least in part on a body pressure map (such as illustrated in FIGS. 2A-2B), and wherein the perforations are configured to allow airflow therethrough directed toward an occupant of the seat 20. Since these examples are similar to the example illustrated in FIGS. 3A-3B, and to avoid unnecessary repetition, they will be discussed in less detail than FIGS. 3A-3B—mostly indicating some differences in the perforation arrangements. Additionally, all of FIGS. 4A-8B may employ registered holes in order to provide the desired air flow while achieving a desired esthetic appearance of the seat surface.

Referring now to FIGS. 4A and 4B, in view of FIG. 1-2B, in this example, the seat back 32 has a higher density of perforations 60 (higher air permeability) in a lower and mid-back area 68 of the outer trim layer 62 that is adjacent to the area that a seat occupant’s lower and mid-back (generally spaced from the spine) may be disposed when sitting in the seat relative to the density of perforations (lower air permeability) in an upper back, hip and spine area 70 of the outer trim layer 62. For the side support areas 72 that are outboard of the back areas 68 and 70 (e.g., outboard of trenches 74), these areas 72 may have very few or no perforations. Also, in this example, the seat bottom 30 has a higher density of perforations 76 (higher air permeability) in a seat buttock and thigh area 78 of the outer trim layer 66 that is adjacent to the area that a seat occupant’s buttock and thighs may be disposed when sitting in the seat relative to the density of perforations (lower air permeability) in an area 80 of the outer trim layer 66 that is the area that is in between and outside of where a seat occupant’s thighs may be disposed and rearward of the buttock. In this example, while the perforations 64 may possibly be larger in the thigh area relative to the buttock area, the overall air permeability may be lower due to the total area for airflow through the perforations being less. For the side support areas 82 that are outboard of the areas 78, 80 (outboard of trenches 84), these areas 82 may have very few or no perforations.

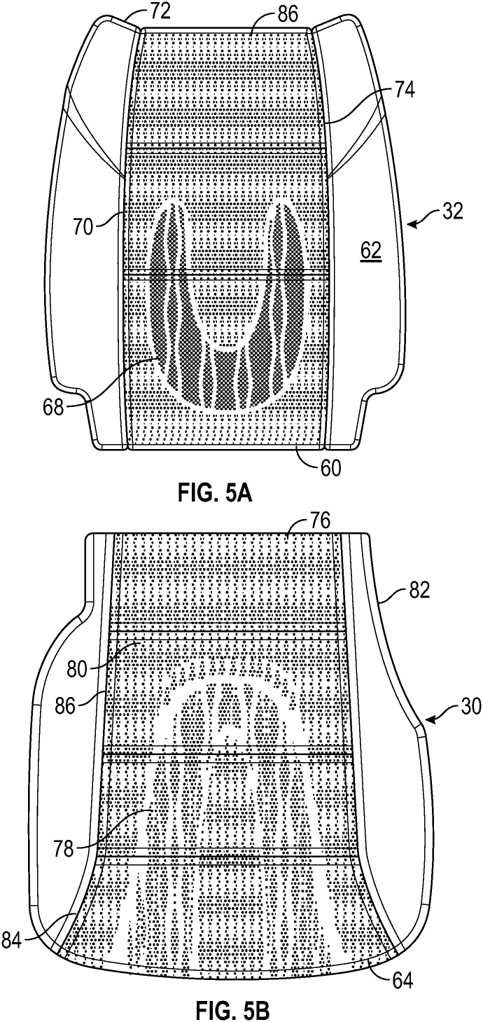

Referring now to FIGS. 5A and 5B, in view of FIG. 1-2B, in this example, the seat back 32 has a higher density of perforations 60 (higher air permeability) in a lower and mid-back area 68 of the outer trim layer 62 that is adjacent to the area that a seat occupant’s lower and mid-back (generally spaced from the spine) may be disposed when sitting in the seat relative to the density of perforations (lower air permeability) in an upper back, shoulders, hip and part of a spine area 70 of the outer trim layer 62. For the side support areas 72 that are outboard of the back areas 68 and 70 (e.g., outboard of trenches 74), these areas 72 may have very few or no perforations. Also, in this example, the seat bottom 30 has a higher density of perforations 76 (higher air permeability) in a seat buttock and thigh area 78 of the outer trim layer 66 that is adjacent to the area that a seat occupant’s buttock and thighs may be disposed when sitting in the seat relative to the density of perforations (lower air permeability) in an area 80 of the outer trim layer 66 that is the area that is in between and outside of where a seat occupant’s thighs may be disposed and rearward of the buttock area. In this example, while the perforations 64 may possibly be larger in the thigh area relative to the buttock area, the overall air permeability may be lower due to the total area for airflow through the perforations being less. Also note, in this example, that, while the overall air permeability may be higher overall in the areas just discussed above, patterns in the perforations may be provided for esthetic appeal. Additionally, the seat surface in the shoulder area and trench adjacent areas may employ some or all registered holes 86 since there may be little or no body pressure on this portion of the seat surface. For the side support areas 82 that are outboard of the areas 78, 80 (outboard of trenches 84), these areas 82 may have very few or no perforations.

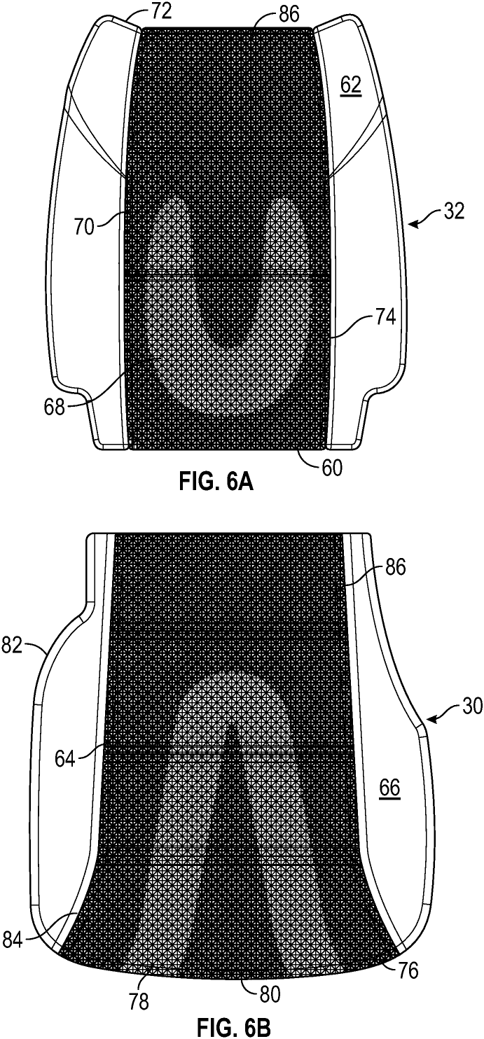

Referring now to FIGS. 6A and 6B, in view of FIG. 1-2B, in this example, the seat back 32 has a higher density of perforations 60 (higher air permeability) in a lower and mid-back area 68 of the outer trim layer 62 that is adjacent to the area that a seat occupant’s lower and mid-back (generally spaced from the spine) may be disposed when sitting in the seat relative to the density of perforations (lower air permeability) in an upper back, shoulders, hip and part of a spine area 70 of the outer trim layer 62. For the side support areas 72 that are outboard of the back areas 68 and 70 (e.g., outboard of trenches 74), these areas 72 may have very few or no perforations. Also, in this example, the seat bottom 30 has a higher density of perforations 76 (higher air permeability) in a seat buttock and thigh area 78 of the outer trim layer 66 that is adjacent to the area that a seat occupant’s buttock and thighs may be disposed when sitting in the seat relative to the density of perforations (lower air permeability) in an area 80 of the outer trim layer 66 that is the area that is in between and outside of where a seat occupant’s thighs may be disposed and rearward of the buttock area. In this example, while the perforations 64 may possibly be larger in the thigh area relative to the buttock area, the overall air permeability may be lower due to the total area for airflow through the perforations being less. Also note, in this example, that, while the overall air permeability may be higher overall in the areas just discussed above, patterns in the perforations may be provided for esthetic appeal. Additionally, the seat surface in the shoulder area and trench adjacent areas may employ some or all registered holes 86 since there may be little or no body pressure on this portion of the seat surface. For the side support areas 82 that are outboard of the areas 78, 80 (outboard of trenches 84), these areas 82 may have very few or no perforations.

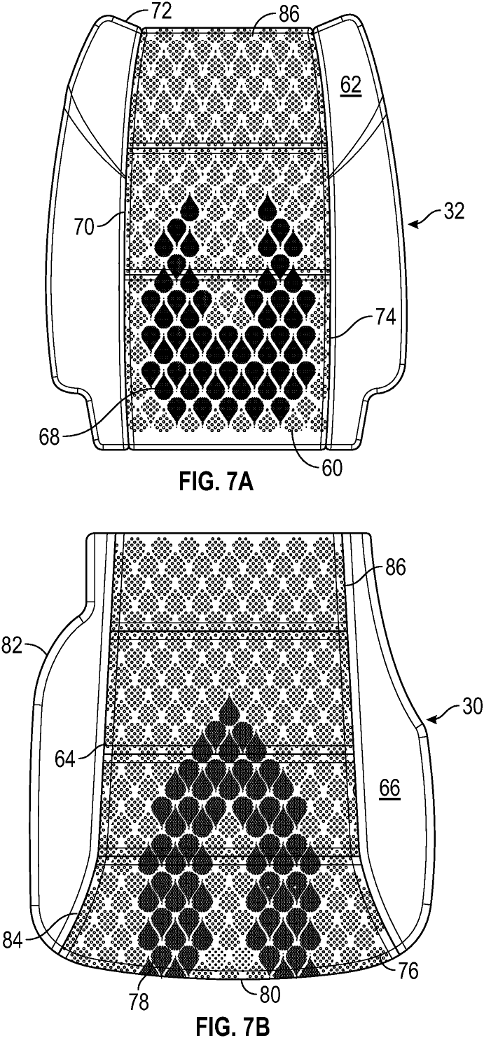

Referring now to FIGS. 7A and 7B, in view of FIG. 1-2B, in this example, the seat back 32 has a higher density of perforations 60 (higher air permeability) in a lower and mid-back area 68 of the outer trim layer 62 that is adjacent to the area that a seat occupant’s lower and mid-back (generally spaced from the spine) may be disposed when sitting in the seat relative to the density of perforations (lower air permeability) in an upper back, shoulders, hip and part of a spine area 70 of the outer trim layer 62. For the side support areas 72 that are outboard of the back areas 68 and 70 (e.g., outboard of trenches 74), these areas 72 may have very few or no perforations. Also, in this example, the seat bottom 30 has a higher density of perforations 76 (higher air permeability) in a seat buttock and thigh area 78 of the outer trim layer 66 that is adjacent to the area that a seat occupant’s buttock and thighs may be disposed when sitting in the seat relative to the density of perforations (lower air permeability) in an area 80 of the outer trim layer 66 that is the area that is in between and outside of where a seat occupant’s thighs may be disposed and rearward of the buttock area. In this example, while the perforations 64 may possibly be larger in the thigh area relative to the buttock area, the overall air permeability may be lower due to the total area for airflow through the perforations being less. Also note, in this example, that, while the overall air permeability may be higher overall in the areas just discussed above, patterns in the perforations may be provided for esthetic appeal. Additionally, the seat surface in the shoulder area and trench adjacent areas may employ some or all registered holes 86 since there may be little or no body pressure on this portion of the seat surface. For the side support areas 82 that are outboard of the areas 78, 80 (outboard of trenches 84), these areas 82 may have very few or no perforations.

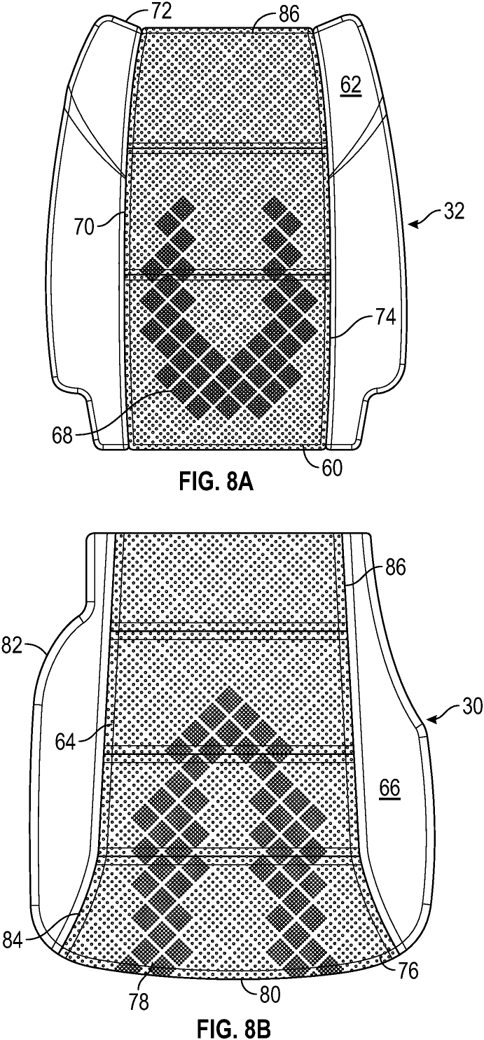

Referring now to FIGS. 8A and 8B, in view of FIG. 1-2B, in this example, the seat back 32 has a higher density of perforations 60 (higher air permeability) in a lower and mid-back area 68 of the outer trim layer 62 that is adjacent to the area that a seat occupant’s lower and mid-back (generally spaced from the spine) may be disposed when sitting in the seat relative to the density of perforations (lower air permeability) in an upper back, shoulders, hip and part of a spine area 70 of the outer trim layer 62. For the side support areas 72 that are outboard of the back areas 68 and 70 (e.g., outboard of trenches 74), these areas 72 may have very few or no perforations. Also, in this example, the seat bottom 30 has a higher density of perforations 76 (higher air permeability) in a seat buttock and thigh area 78 of the outer trim layer 66 that is adjacent to the area that a seat occupant’s buttock and thighs may be disposed when sitting in the seat relative to the density of perforations (lower air permeability) in an area 80 of the outer trim layer 66 that is the area that is in between and outside of where a seat occupant’s thighs may be disposed and rearward of the buttock area. In this example, while the perforations 64 may possibly be larger in the thigh area relative to the buttock area, the overall air permeability may be lower due to the total area for airflow through the perforations being less. Also note, in this example, that, while the overall air permeability may be higher overall in the areas just discussed above, patterns in the perforations may be provided for esthetic appeal. Additionally, the seat surface in the shoulder area and trench adjacent areas may employ some or all registered holes 86 since there may be little or no body pressure on this portion of the seat surface. For the side support areas 82 that are outboard of the areas 78, 80 (outboard of trenches 84), these areas 82 may have very few or no perforations.

The principle and mode of operation of this invention have been explained and illustrated in its preferred embodiment. However, it must be understood that this invention may be practiced otherwise than as specifically explained and illustrated without departing from its spirit or scope.

1. A seat comprising:
a seat bottom; and
a seat back operatively engaging the seat bottom, wherein:
at least one of the seat back and the seat bottom has having an air impermeable outer trim layer covering at least a portion of an outer surface,
the air impermeable outer trim layer has perforations that extend therethrough and are configured to allow airflow toward an occupant of the seat,
the size, spacing, or both of the perforations are varied throughout the air impermeable outer trim layer based at least in part on a body pressure map, and
the air impermeable outer trim layer has registered holes that do not extend therethrough.

2. The seat of claim 1 wherein the air impermeable outer trim layer includes a first area having a first air permeability resulting from a size, spacing, or both of the perforations therein and a second area having a second air permeability resulting from the size, spacing, or both of the perforations therein that is lower than the first air permeability.

3. The seat of claim 2 wherein the first air permeability and the second air permeability are both non-zero, and the air impermeable outer trim layer includes a third area resulting from the registered holes, having a third air permeability that is about zero.

4. The seat of claim 1 wherein at least a portion of the registered holes cooperate with the perforations to create an appearance of a perforation pattern.

5. The seat of claim 3 wherein at least a portion of the third area further includes a trench in the air impermeable outer trim layer.

6. (canceled)

7. The seat of claim 1 wherein the seat further includes a climate control system configured to direct heated air, cooled air, or both through the perforations.

8. The seat of claim 2 wherein the first area of the air impermeable outer trim layer is generally associated with a buttock location of the occupant of the seat, and the second area of the air impermeable outer trim layer is generally associated with an area between, outside of, or both thigh locations of the occupant of the seat.

9. The seat of claim 8 wherein the first air permeability and the second air permeability are both non-zero, and the air impermeable outer trim layer includes a third area, having a third air permeability that is about zero.

10. The seat of claim 2 wherein the first area of the air impermeable outer trim layer is generally associated with a lower back location of the occupant of the seat, and the second area of the air impermeable outer trim layer is generally associated with an upper back area of the occupant of the seat.

11. The seat of claim 10 wherein the first air permeability and the second air permeability are both non-zero, and the air impermeable outer trim layer includes a third area having a third air permeability that is about zero.

12. The seat of claim 1 wherein the air impermeable outer trim layer is formed from at least one of leather or vinyl.

13. A seat comprising:
a seat bottom; and
a seat back operatively engaging the seat bottom, wherein:
at least one of the seat back and the seat bottom has an air impermeable outer trim layer covering at least a portion of an outer surface,
the air impermeable outer trim layer has perforations that extend therethrough and are configured to allow airflow toward an occupant of the seat,
the air impermeable outer trim layer includes a first area having a first air permeability resulting from a size, spacing, or both of the perforations therein and a second area having a second air permeability resulting from the size, spacing, or both of the perforations therein that is lower than the first air permeability.

14. The seat of claim 13 wherein the first air permeability and the second air permeability are both non-zero.

15. The seat of claim 13 where the air impermeable outer trim layer includes a third area having a third air permeability that is less than the second air permeability.

16. The seat of claim 15 wherein the third area includes areas adjacent to a trench in the air impermeable outer trim layer.

17. The seat of claim 13 wherein the seat further includes a climate control system configured to direct heated air, cooled air, or both through the perforations.
